(19) United States
(12) Patent Application Publication
(10) Pub. No.: US 2025/0156608 A1
(43) Pub. Date: May 15, 2025

(54) NUCLEAR-THERMAL COUPLING IMPLEMENTATION METHOD BASED ON DEEPM&MNET NEURAL NETWORK

(71) Applicant: SHANGHAI JIAO TONG UNIVERSITY, Shanghai (CN)

(72) Inventors: Xiaojing Liu, Shanghai (CN); Hongtao Bi, Shanghai (CN); Meiqi Song, Shanghai (CN)

(73) Assignee: SHANGHAI JIAO TONG UNIVERSITY, Shanghai (CN)

(21) Appl. No.: 18/743,154

(22) Filed: Jun. 14, 2024

(30) Foreign Application Priority Data
Nov. 13, 2023 (CN) 202311499975.9

(51) Int. Cl. G06F 30/27; G06F 111/10; G06F 119/08

(52) U.S. Cl. CPC G06F 30/27; G06F 2111/10; G06F 2119/08

(57) ABSTRACT

A method for implementing nuclear-thermal coupling based on the DeepM&Mnet neural network is disclosed; the proposed nuclear-thermal coupling implementation method comprises the following steps; first construct DeepM&Mnet neural network inclusive of numerical solvers for the material temperature and neutron physics fields; then the DeepM&Mnet neural network is trained by utilizing physics constraints of the numerical solvers for the material temperature and neutron physics fields; finally, the formation of the network loss function is adjusted based on the training results to achieve nuclear-thermal coupling simulation; according to the method, a numerical solver for material temperature and neutron physics fields, or a deep operator network (DeepONet) is applied for fitting a numerical solution process, and a DeepM&Mnet is constructed on the basis.

### CROSS-REFERENCE TO RELATED APPLICATIONS

This application claims priority to Chinese Patent Application Ser. No. CN202311499975.9 filed on 13 Nov. 2023.

### TECHNICAL FIELD

The invention relates to a technology in the field of nuclear reactor control, specifically, it's a nuclear-thermal coupling implementation method based on deep multi-physics and multi-scale neural network (DeepM&Mnet).

### BACKGROUND

Current nuclear-thermal coupling calculation process relies on existing coupling iterative calculation methods, which has many limitations. For instance, it is only applicable to certain specific situations, the convergence speed is slow, and the numerical accuracy during the calculation process is low. In addition, many methods are highly dependent on existing neutron physics calculation programs and thermal-hydraulic calculation programs, which challenge the convergence of the calculation process.

### SUMMARY OF THE INVENTION

The present invention, in response to the issues with existing technology including difficulty in solving new problems without databases, long pre-training processes, and low accuracy, proposes a nuclear-thermal coupling implementation method based on DeepM&Mnet neural network. The proposed coupling implementation method, by using numerical solvers for the material temperature field and neutron physics field, or fitting numerical solution processes through the use of deep operator network (DeepONet), and building a DeepM&Mnet neural network on this basis, is capable of realizing nuclear-thermal coupling calculation and obtaining fast convergence and more accurate results. This invention is of great significance for nuclear numerical simulation and multi-physics calculation simulation for nuclear reactor cores.

The present invention is realized through the following technical solutions:

The invention relates to a method for realizing nuclear-thermal coupling calculation based on deep multi-physics and multi-scale (DeepM&Mnet) neural network comprising a computer readable medium operable on a computer with memory for the nuclear-thermal coupling implementation method. The nuclear-thermal coupling simulation is achieved by constructing a DeepM&Mnet neural network that contains a numerical solver for the material temperature field and neutron physics field, using physical constraints of the numerical solver to train the DeepM&Mnet neural network, and adjusting composition of loss function of DeepM&Mnet neural network depending on training results.

The DeepM&Mnet neural network includes: discrete unit, fully-connected layers, material temperature field solver, neutron physics field solver and loss calculation unit. The discrete unit discretizes the space and time coordinates, attaining a customized space-time grid point matrix. The fully-connected layers, based on the information obtained from the discrete unit, predict the physical field data on the discrete grid points.

The material temperature field solver calculates the corresponding material temperature field under the predicted neutron physics field from the fully-connected layers, and the neutron physics field solver calculates the corresponding neutron physics field under the predicted material temperature field from the fully-connected layer alike. The loss calculation unit reads observation data and physical field data from the previous units, constructing a loss function to calculate the loss function of the DeepM&Mnet neural network in a parallel or serial manner. Then the DeepM&Mnet neural network continuously updates the parameters of the fully-connected layers during the loss minimization process, and finally obtains the nuclear-thermal coupling calculation results of the set models.

The parallel computing manner refers to: the fully-connected layers predict the physical quantities of all physical fields, and the loss calculation unit correspondingly needs to calculate the prediction loss of all physical fields, which obtains higher calculation accuracy at a lower calculation speed.

The serial computing manner refers to: the fully-connected layers predict the physical quantity of a single physical field, and the loss calculation unit only needs to calculate the prediction loss of this physical quantity, which results in a higher computational speed but a relatively lower accuracy.

The material temperature field solver uses the existing numerical solution computation programs based on the heat conduction differential equation to numerically solve the material temperature field of the set geometric model. This effectively replaces the pre-training process of DeepONet.

The neutron physics field solver uses the existing numerical solution computation programs based on the neutron diffusion equation to numerically solve the neutron physics field of the set geometric model. This effectively replaces the pre-training process of DeepONet.

The invention involves a system that implements the above method, which includes: a neutron diffusion equation calculation module, a thermal conduction differential equation calculation module, an operator neural network (DeepONet) module, a network training module and a nuclear-thermal coupling numerical solution module. The neutron diffusion equation calculation module solves the multi-group neutron diffusion equation using the source iteration computation method, obtaining the relative distribution of neutron flux in various neutron groups under the set temperature field of the geometric model. The heat conduction differential equation calculation module uses a numerical discretization method to calculate the distribution of internal heat sources generated by the set neutron flux field, and generates the temperature field distribution of the geometric model. The operator neural network module performs fitting on the multi-group neutron diffusion equation and heat conduction differential equation based on the open-source DeepXDE library to derive a corresponding numerical solution proxy model. The network training module constructs a nuclear-thermal coupling computing neural network based on tensorflow2.0, the neutron diffusion equation and heat conduction differential equation solver to obtain the numerical results of the temperature field and neutron physics field for the geometric model's nuclear-thermal coupling. The nuclear-thermal coupling numerical solution module uses the neutron diffusion equation calculation module and the thermal conduction differential equation calculation module to achieve the numerical solution results for the geometric model's nuclear-thermal coupling through numerical iteration, serving as the verification for the training results of the DeepM&Mnet neural network.

### Technical Effect

The present invention uses the features of DeepM&Mnet neural network to solve multi-scale and multi-physics coupling problems. For the coupling physical phenomena of material temperature and neutron physics field to be calculated, it can perform high-precision nuclear-thermal coupling in the field of nuclear reactor numerical calculations. Compared with the existing technology, the coupling process of the present invention does not directly use temporary results in the iteration as the input of the next iteration step. Moreover, it demonstrates good convergence in the calculation of nuclear-thermal coupling and other forward problems using the DeepM&Mnet neural network.

### BRIEF DESCRIPTION OF DRAWINGS

FIG. 1 is a flowchart of the present invention.

FIG. 2a is a schematic diagram of the DeepM&Mnet nuclear-thermal coupling neural network structure: serial DeepM&Mnet neural network.

FIG. 2b is a schematic diagram of the DeepM&Mnet nuclear-thermal coupling neural network structure: parallel DeepM&Mnet neural network.

FIG. 3 is the geometric structure of a single-rod nuclear-thermal coupling example.

In the picture: 1 cladding, 2 fuel;

FIG. 4a is a diagram showing the decrease of the DeepM&Mnet training loss: parallel DeepM&Mnet training loss.

FIG. 4b is a diagram showing the decrease of the DeepM&Mnet training loss: serial DeepM&Mnet training loss.

FIG. 5 is a schematic diagram of the neutron flux distribution results after the DeepM&Mnet nuclear-thermal coupling computation.

FIG. 6 is a schematic diagram of the temperature distribution results after the DeepM&Mnet nuclear-thermal coupling computation.

### DETAILED DESCRIPTION OF THE INVENTION

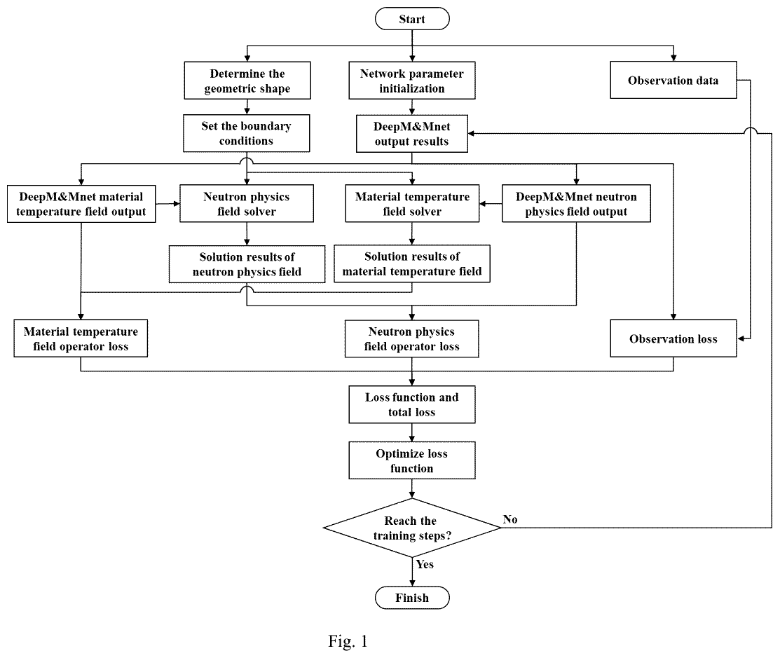

As shown in FIG. 1, this embodiment involves a method for realizing nuclear-thermal coupling of a single nuclear reactor fuel rod. By constructing a DeepM&Mnet neural network that includes numerical solvers for the material temperature field and the neutron physics field, the physical constraints of the numerical solvers help to train the parameters of the fully-connected layers in the DeepM&Mnet neural network. The composition of the network loss function is adjusted according to the training results, obtaining more accurate and convergent results for the single-rod nuclear-thermal coupling calculation. This specifically comprises a computer readable medium operable on a computer with memory for the nuclear-thermal coupling implementation method, and comprising program instructions for executing the following steps of: the following steps:

Step 1) set physical and geometric parameters of a calculation model; based on the physical and geometric parameters, build corresponding numerical solvers, which comprises:
1.1 set the detailed geometric parameters of the nuclear reactor core to be calculated, such as height, length, etc.;
1.2 set physical properties of the material temperature field and neutron physics field in the reactor core calculation area, such as reaction cross section, thermal conductivity, etc., and set the boundary conditions of the calculation parameters; and
1.3 based on the determined core calculation model, build the corresponding temperature field numerical solver and neutron field numerical solver.

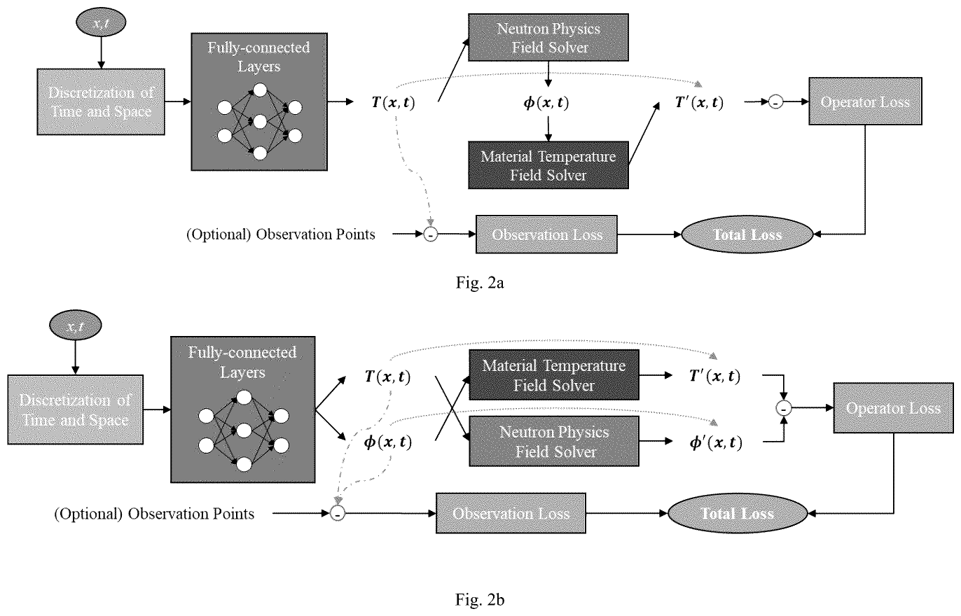

Step 2) adopt the DeepM&Mnet neural network shown in FIG. 2, set the parameters of the DeepM&Mnet neural network based on the calculation model in step 1, which comprises:
2.1 set the domain range and discretization method of time scale and spatial coordinates as the inputs of the fully-connected layers inside the DeepM&Mnet neural network;
2.2 set the relevant parameters of the fully-connected layers in the DeepM&Mnet neural network, including the number of layers in the fully-connected layer, the number of nodes in each layer, etc.;
2.3 set the parameters related to the training process, including training initialization parameters, optimizer selection, learning rate, number of training step, etc.; and
2.4 set the loss function, which specifically is: arg min_{θ} [symbol] =λ_{data} [symbol] _{data}+λₒₚ [symbol] +λ_{reg} [symbol] (θ), where: λ_{data} is the observation loss coefficient, [symbol] is the observation loss, λₒₚ is the operator loss coefficient, [symbol] is the operator loss, λ_{reg} is the regularization coefficient, and [symbol] (θ) is the parameter L2 regularization.

The operator loss is composed of the difference between the outputs of the fully-connected layers and the calculation results of the corresponding solvers. The observation loss is the difference between the mismatched value of some specific observations and the true values. The L2 regularization of the trainable parameters is used to alleviate the network overfitting phenomenon. The coefficients before each term in the loss function also need to be set.

Step 3) train and optimize the DeepM&Mnet neural network according to the parameters in step 2, which comprises:
3.1 read the output of the fully-connected layers at each step of the training process, calculate the loss according to the definition of the loss function and minimize the loss function;
3.2 monitor each training step, record the loss data, the predicted material temperature field and neutron flux field data during each training process, and post-process the data into visual images; and
3.3 if the pre-designed number of training step has not been reached, repeat steps 3.1 and 3.2 until the number of training step is reached or the loss is reduced to an acceptable value, and then the training process can be terminated.

The output data of the fully-connected layers in the trained DeepM&Mnet neural network is consistent with the nuclear-thermal coupling results of the reactor core model to be calculated. Since the DeepM&Mnet neural network loss function training process does not directly use the output results in the previous iteration step as the input of the next iteration step, this calculation method has good convergence and fast convergence speed, which is of great significance for nuclear-thermal coupling calculation of nuclear reactor cores.

Step 4) use the trained DeepM&Mnet neural network to specifically carry out the nuclear-thermal coupling simulation.

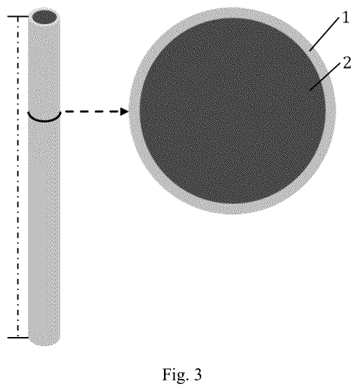

After specific practical experiments, the nuclear-thermal coupling process of a simplified model-a MOX single nuclear fuel rod in a fast reactor was calculated. The nuclear fuel single rod model in the reactor core is shown in FIG. 3, where the single rod radius is 0.50 cm, the overall height is 90 cm, the fuel area radius is 0.45 cm, and the cladding thickness is 0.05 cm. Set the external temperature boundary of the cladding to a fixed 700K temperature boundary and neutron total reflection boundary. Set the upper and lower surfaces of the single rod to adiabatic boundary and neutron vacuum boundary. On this basis, initialize the numerical solution module and the DeepM&Mnet neural network module.

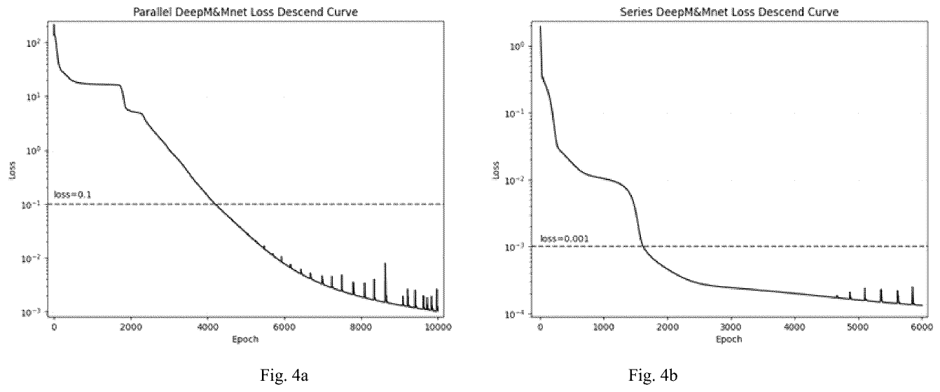

For this model, both serial and parallel DeepM&Mnet neural network nuclear-thermal coupling calculations were performed respectively. During the coupling calculations, set the number of DeepM&Mnet neural network training step to 10,000 times, set the operator loss coefficient in the loss function to 0.500, the observation loss coefficient to 0.499, the training parameter L2 regularization parameter to 0.001, and use Adams optimizer with a learning rate of 0.0001. As shown in FIG. 4, both the serial and parallel DeepM&Mnet losses dropped to less than 0.01 with a continuous downward trend at the training step of 6000. In other words, the output results of the fully-connected layers in the DeepM&Mnet neural network were continuously approaching the final nuclear-thermal coupling steady-state results of the single rod model.

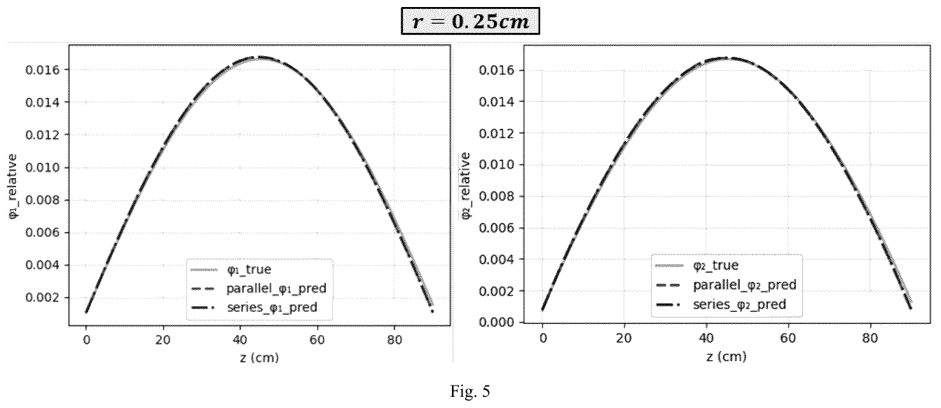

As shown in FIG. 5, the final neutron flux results of the nuclear-thermal coupling process after the serial and parallel DeepM&Mnet training process are displayed. After normalization, at the r=0.25 cm interface, the L2 norm relative errors of the prediction results for group 1 neutron flux attained by serial and parallel DeepM&Mnet compared with the MOOSE numerical calculation results are 1.7341% and 1.6768% respectively; for group 2 neutron flux the relative L2 norm relative errors are 1.6990% and 1.6564%. The curve of neutron flux is consistent with the numerical solution results, with the neutron flux reaching the maximum at the center of the single rod, and the axial change is larger than the radial change.

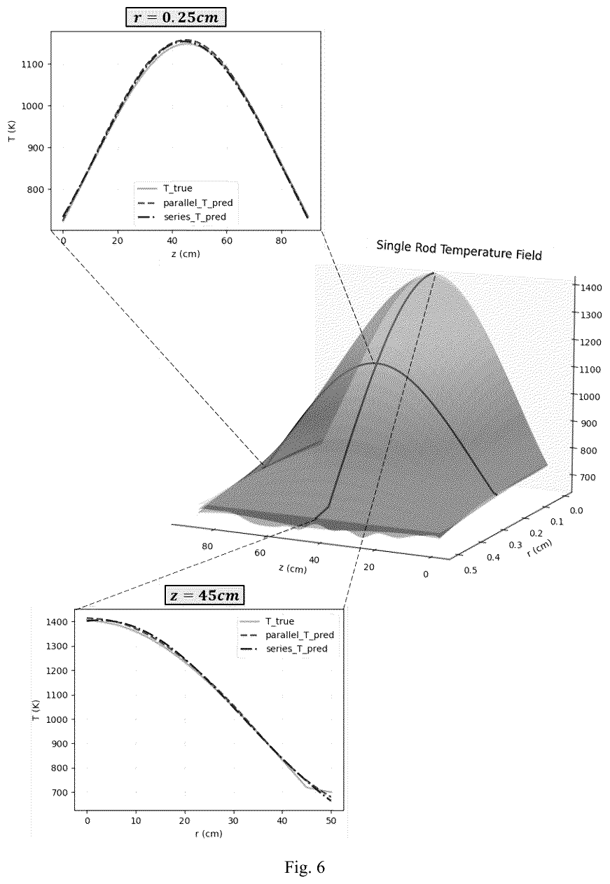

As shown in FIG. 6, the final temperature field results of the nuclear-thermal coupling process after the serial and parallel DeepM&Mnet training process are displayed. The temperature field calculation results of the serial and parallel DeepM&Mnet range from 687.85034K-1425.70560K, with the L2 norm relative errors of 0.8901% and 0.8381% respectively compared to the MOOSE numerical calculation results. The spatial distribution curve of the temperature field is basically consistent with the numerical solution results, and the highest temperature is reached at the center of the single rod. From the above simulation results, after 6000 steps of serial and parallel DeepM&Mnet training, the losses are reduced to less than 0.01 with a continuous downward trend. The highest temperature of the whole fuel rod is 1425.70560K. After comparing with the MOOSE numerical calculation, the L2 norm relative errors of the temperature field between DeepM&Mnet nuclear-thermal coupling results and numerical calculation results are 0.8901% and 0.8381%, the group 1 neutron flux L2 norm relative errors are 1.7341% and 1.6768%, and the group 2 neutron flux L2 norm relative errors are 1.6990% and 1.6564%, indicating good calculation convergence and acceptable error.

Performing the nuclear-thermal coupling simulation based on results of nuclear-thermal coupling implementation method.

In summary, by building the DeepM&Mnet nuclear-thermal coupling neural network, the present invention can realize the nuclear-thermal coupling numerical simulation of the neutron physics field and material temperature field for a set geometric model.

The above-mentioned specific implementations can be partially adjusted in different ways by those skilled in the art without deviating from the principles and objectives of the present invention. The scope of protection of the present invention is defined by the claims and is not limited by the above-mentioned specific implementations. Each implementation scheme within its scope is constrained by this invention.

What is claimed are:

1. A nuclear-thermal coupling implementation method based on deep multi-physics and multi-scale (DeepM&Mnet) neural network comprising a computer readable medium operable on a computer with memory for the nuclear-thermal coupling implementation method, and comprising program instructions for executing the following steps of:
constructing the DeepM&Mnet neural network that contains a numerical solver for the material temperature field and neutron physics field, using physical constraints of the numerical solver to train the DeepM&Mnet neural network, and adjusting composition of loss function of DeepM&Mnet neural network depending on training results to achieve nuclear thermal coupling simulation; performing the nuclear-thermal coupling simulation based on results of nuclear-thermal coupling implementation method.

2. The nuclear-thermal coupling implementation method according to claim 1, wherein in building the DeepM&Mnet neural network comprises: discrete unit, fully connected layers, material temperature field solver, neutron physics field solver, and loss calculation unit; the discrete unit discretizes the space coordinates and time coordinates, attaining a customized space-time grid point matrix; the fully-connected layers, based on the information obtained from the discrete unit, predict the physical field data on the discrete grid points; the material temperature field solver calculates the corresponding material temperature field under the predicted neutron physics field from the fully-connected layer, and the neutron physics field solver calculates the corresponding neutron physics field under the predicted material temperature field from the fully-connected layer alike; the loss calculation unit reads observation data and physical field data from the previous units, constructing a loss function to calculate the loss function of the DeepM&Mnet neural network in a parallel or serial manner; then the DeepM&Mnet neural network continuously updates the parameters of the fully-connected layers during the loss minimization process, and finally obtains the nuclear-thermal coupling calculation results of the set models.

3. The nuclear-thermal coupling implementation method according to claim 2, wherein the parallel method comprises the fully-connected layers predict the physical quantities of all physical fields, and the loss calculation unit correspondingly needs to calculate the prediction loss of all physical fields, which obtains higher calculation accuracy at a lower calculation speed; the sequential method comprises the fully-connected layers predict the physical quantity of a single physical field, and the loss calculation unit only needs to calculate the prediction loss of this physical quantity, which results in a higher computational speed but a relatively lower accuracy.

4. The nuclear-thermal coupling implementation method according to claim 3, wherein the nuclear-thermal coupling implementation method further comprises the following steps:
step 1) set physical and geometric parameters of a calculation model; based on the physical and geometric parameters, build corresponding numerical solvers, which comprises:
1.1 set and calculate the geometric size parameters of a nuclear reactor cores;
1.2 set calculation parameters of the material temperature field and neutron physics field of the reactor core calculation area, and set the boundary conditions of the calculation parameters; and
1.3 based on the determined core calculation model, build the corresponding temperature field numerical solver and neutron field numerical solver;
step 2) adopt the DeepM&Mnet neural network and set the parameters of the DeepM&Mnet neural network based on the calculation model in the step 1), which comprises:
2.1 set the domain range and the discretization method of time scale and spatial coordinates as inputs to the fully-connected layers inside the DeepM&Mnet neural network;
2.2 set the relevant parameters of the fully-connected layers inside the DeepM&Mnet neural network;
2.3 set the parameters related to the training process; and
2.4 set the loss function, which specifically is: arg min_{θ} [symbol] =λ_{data} [symbol] +λₒₚ [symbol] +λ_{reg} [symbol] (θ), where: λ_{data} is the observation loss coefficient, [symbol] is the observation loss, λₒₚ is the operator loss coefficient, [symbol] is the operator loss, λ_{reg} is the regularization coefficient, and [symbol] (θ) is the parameter L2 regularization;
step 3) train and optimize the DeepM&Mnet neural network according to the parameters of the step 20, which comprises:
3.1 read the outputs of the fully-connected layers at each step of the training process, calculate the loss according to the definition of the loss function and minimize the loss function;
3.2 monitor each training step, record the loss data, the predicted material temperature field and neutron flux field data during each training process, and post-process the data into visual images; and
3.3 if the pre-defined number of training step has not been reached, repeat step 3.1 and 3.2 until the number of training step is reached or the loss is reduced to an acceptable value; then the training process can be terminated;
step 4) use the trained DeepM&Mnet neural network to specifically carry out the nuclear-thermal coupling simulation.

5. A nuclear-thermal coupling implementation system based on the DeepM&Mnet neural network of claim 1, comprising a neutron diffusion equation calculation circuit, a heat conduction differential equation calculation circuit, an operator neural network circuit, a network training circuit and a nuclear-thermal coupling numerical solution circuit; the neutron diffusion equation calculation circuit solves the multi-group neutron diffusion equation using the source iteration computation method, obtaining the relative distribution of neutron flux in various neutron groups under the set temperature field of the geometric model; the heat conduction differential equation calculation circuit uses a numerical discretization method to calculate the distribution of internal heat sources generated by the set neutron flux field, and generates the temperature field distribution of the geometric model; the operator neural network circuit performs fitting on the multi-group neutron diffusion equation and heat conduction differential equation based on the open-source DeepXDE library to derive a corresponding numerical solution proxy model; the network training module constructs a nuclear-thermal coupling computing neural network based on tensorflow2.0, the neutron diffusion equation and heat conduction differential equation solver to obtain the numerical results of the temperature field and neutron physics field for the geometric model's nuclear-thermal coupling; the nuclear-thermal coupling numerical solution module uses the neutron diffusion equation calculation module and the thermal conduction differential equation calculation module to achieve the numerical solution results for the geometric model's nuclear-thermal coupling through numerical iteration, serving as the verification for the training results of the DeepM&Mnet neural network.
